(19) United States
(12) Patent Application Publication
(10) Pub. No.: US 2004/0101031 A1
(43) Pub. Date: May 27, 2004

(54) Temperature sensor with improved response time

(75) Inventor: Allan Joseph Kotwicki, Williamsburg, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 10/065,836

(22) Filed: Nov. 25, 2002

(51) Int. Cl. G01K 1/00; G01K 13/12; G01K 7/00

(52) U.S. Cl. 374/185; 374/100

(57) ABSTRACT

A temperature sensor comprises a temperature sensing element (10) having a coating (30) thereon with a high thermal diffusivity thereon to improve response time of the sensor to changes in temperature. The coating can include a plastic resin matrix containing thermally conductive particles.

### BACKGROUND OF INVENTION

1. Field of the Invention

The present invention relates to a temperature sensor constructed in a manner to improve (decrease) response time to temperature changes.

2. Description of Related Art

In automotive engine control systems, particularly those which use a speed-density air charge system, the air density in the intake manifold is estimated using a combination of a prestored engine map, a measurement of engine manifold pressure, and intake manifold air temperature. During transient operation of the engine, intake manifold air temperature can change rapidly. Present engine systems measure intake manifold air temperature using a temperature sensor mounted on the intake manifold such that an exposed bead thermistor is positioned in the intake manifold to sense air temperature therein. The exposed thermistor bead is protected by an epoxy resin encapsulant or coating that unfortunately prolongs response of the temperature sensor to temperature changes, making correct estimation of air density during transient engine operation conditions difficult.

There is a need to improve such intake manifold air temperature sensors as well as other temperature sensors in order to decrease the response time in sensing changes of temperature.

### SUMMARY OF INVENTION

The present invention provides a temperature sensor comprising a temperature sensing element and a coating on the temperature sensing element wherein the coating has a relatively high thermal diffusivity effective to improve response time of the sensor to changes in temperature. The coating comprises a thermosetting or thermoplastic resin containing thermally conductive filler particles, which may be selected from metallic and non-metallic particles. An electrical insulating coating optionally may be provided between the temperature sensing element and the coating.

In an illustrative embodiment of the invention, the temperature sensor comprises an intake manifold air temperature sensor having a thermistor body with a coating thereon comprising metallic filler particles disposed in a plastic resin matrix. A preferred coating comprises aluminum particle-filled thermosetting epoxy resin. A manifold air temperature sensor having a thermistor body coated pursuant to the invention provides a faster response time to changes in temperature.

The above objects and advantages of the present invention will become more readily apparent from the following description taken with the following drawings.

### BRIEF DESCRIPTION OF DRAWINGS

FIG. 1 is a side elevational view of a manifold air temperature sensor having a temperature sensing thermistor bead coated pursuant to an illustrative embodiment of the invention.

FIG. 2 is an elevational view taken along lines 2-2 of FIG. 2 of the manifold air temperature sensor mounted on an intake manifold.

FIG. 3 is an enlarged elevational view of a coated thermistor bead residing in a protective cage, a portion of the cage being broken away to show the coated thermistor bead.

FIG. 4 is a sectional view of a thermistor bead coated pursuant to an illustrative embodiment of the invention.

FIG. 5 is a sectional view of a thermistor bead coated pursuant to another illustrative embodiment of the invention.

### DETAILED DESCRIPTION

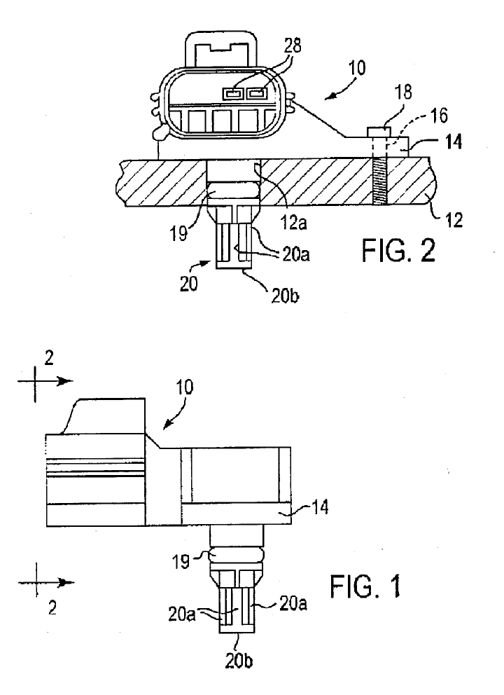

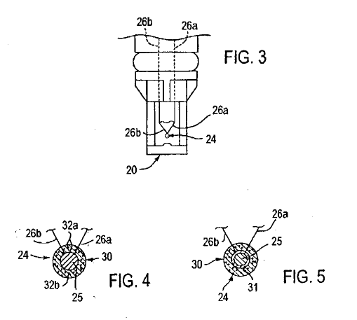

For purposes of illustration and not limitation, an embodiment of the invention is now described with respect to a manifold air temperature sensor 10 shown in FIGS. 1-2 disposed on the intake manifold 12 of an internal combustion engine (not shown). The temperature sensor 10 includes a laterally extending flange 14 having a hole 16 that receives a fastener 18 by which the temperature sensor 10 is mounted on the intake manifold 12. The temperature sensor 10 includes a seal (e.g. O-ring) 19 that provides an air-tight seal against the wall 12a of intake manifold 12 and protective cage 20 that extends downwardly into the intake manifold 12 when the sensor is mounted on the intake manifold by fastener 18. The cage 20 includes a plurality (e.g. four) depending legs 20a and a bottom wall 20b. As shown in FIGS. 3, 4, and 5, a temperature sensing element 24, such as thermistor body or bead 25, is suspended in the cage 20 by rigid lead wires 26a, 26b that are connected electrically to a pair of the output terminals 28 of the temperature sensor 10.

Pursuant to illustrative embodiments of the invention shown in FIGS. 4 and 5, the thermistor bead 25 has a coating 30 thereon selected to exhibit a relatively high thermal diffusivity effective to reduce response time of the sensor. Thermal diffusivity is the ratio of thermal conductivity to thermal mass of a material [e.g. thermal diffusivity=k/ρcₚ where k is thermal conductivity (W/mK) and ρcₚ is thermal mass expressed in units as (k m²)/(ρcₚ s) with ρ being density (kg/mm³), cₚ being specific heat (J/kgK), m being meters and s being seconds]. Thermal diffusivity in effect determines the time scale of the internal temperature-time response of a material to changes in ambient temperature. Coating materials with high thermal diffusivity exhibit a relatively fast response to changes in ambient temperature, reflected in what can be called a “time constant” of the material where the time constant is expressed in units as (ρc_s)/(k m²).

Referring to FIG. 4, for purposes of illustration and not limitation, the coating 30 comprises a particle-filled plastic resin coating disposed on the thermistor bead 25. An illustrative coating 30 comprises thermally conductive filler particles 32a disposed in a thermosetting or thermoplastic resin matrix 32b. A preferred coating 30 comprises aluminum filler particles 32a present in an epoxy resin matrix 32b. An aluminum particle-filled epoxy resin material suitable for coating 30 is available as AREMCO 805 material or AREMCO 568 material from Aremco Products, Inc., P.O. Box 517, 707-B Executive Boulevard, Valley Cottage, N.Y. 10989. The coating 30 also can comprise a resin matrix containing thermally conductive non-metallic particles. For example, the coating 30 can comprise a thermally conductive, aluminum nitride particle-filled epoxy resin coating or layer. An aluminum nitride particle-filled epoxy resin material useful for forming such a coating 30 is available as AREMCO 860 material from the above-mentioned source. The above-mentioned AREMCO 805, 568, and 860 particle-filled epoxy resin materials are advantageous in that the coating 30 after curing is thermally conductive and yet exhibits relatively high electrical resistance (e.g., a volume resistivity of 1.0×10⁵ ohms-cm for AREMCO 805 and 568 materials and 1.0×10¹⁵ ohms-cm for AREMCO 860 material).

Although certain coating materials are described above, the invention is not limited and can be practiced using any suitable thermosetting or thermoplastic resin-based material, such as including but not limited to epoxy resins, containing thermally conductive particles. The thermally conductive particles can include, but are not limited to, aluminum, silver, copper, brass, steel, stainless steel, aluminum nitride and other thermally conductive particles.

A thermistor bead 25 having a coating 30 pursuant to the invention will exhibit a response time to temperature changes that is faster than that of a similar thermistor bead coated with or encapsulated in an unfilled (particle-free) epoxy resin coating of the same thickness. A typical thickness of the coating 30 is in the range of 0.1 to 1 mm (millimeter).

For example, the thermal diffusivity of the aluminum particle-filled AREMCO 805 epoxy resin material is about 1.0272×10⁻⁶ (k m²)/(ρcₚ s) as compared to a thermal diffusivity of only 1.614×10⁻⁷ (k m²)/(ρcₚ s) for unfilled epoxy resin where thermal conductivity, k, of the aluminum particle-filled epoxy resin material is about 1.8028 W/mK and of unfilled epoxy resin is 0.187 W/mK. The time constant of the aluminum particle-filled epoxy resin material is about 9.7352×10⁵ (ρcₚ s)/(k m²) as compared to a higher time constant of 6.197×10⁶ (ρcₚ s)/(k m²) for unfilled epoxy resin.

The coating 30 can be applied to the thermistor bead 25, or other temperature sensing element, by dipping, spraying or other coating process depending on the viscosity of the coating material being applied.

Referring to FIG. 5, pursuant to another illustrative embodiment of the invention where like features are represented by like references, the thermistor bead 25 is coated to include a relatively thin, unfilled resin (e.g. particle-free epoxy resin) inner coating 31 and a relatively thick, particle-filled resin outer coating 30 of the type described above. The inner coating 31 is electrically insulating and has a thickness in the range of 0.01 to 0.05 mm to minimize adverse effects on sensor response time. A typical thickness of the outer particle-filled plastic resin coating 30 is in the range of 0.1 to 1 mm. Use of the electrically insulating inner coating 31 is beneficial if an outer coating 30 is used having a high loading or content of the thermally conductive particles 32a.

While the invention has been described for purposes of illustration with respect to manifold air temperature sensor 10 of FIGS. 1-2, the invention is not so limited. For example, the invention can be practiced in connection with other types of temperature sensors to coat or encapsulate a temperature sensing element, such as a thermocouple, thermopile or other sensing element, to improve (reduce) the response time of the temperature sensor to changes in temperature of a gas, liquid, or solid. The invention also can be practiced in connection with thin film temperature measuring devices or sensors. For example, a resistive temperature measuring device (RTD) typically includes a platinum layer sputtered on a temperature sensing thin film resistor. Pursuant to the invention, a coating 30 as described hereabove pursuant to the invention can be applied on the RTD in lieu of a glass cover used heretofore to protect the RTD.

Moreover, while the invention has been described in terms of specific embodiments thereof, it is not intended to be limited thereto but rather only as set forth in the appended claims.

What is claimed is:

1. A temperature sensor, comprising a temperature sensing element and a coating thereon comprising thermally conductive particles in a resin matrix.

2. The sensor of claim 1 wherein said coating material comprises a metallic particles in said resin matrix.

3. The sensor of claim 2 wherein said metallic particles comprise aluminum particles.

4. The sensor of claim 1 wherein said coating material comprises non-metallic particles in said resin matrix.

5. The sensor of claim 1 wherein said temperature sensing element comprises a thermistor bead.

6. The sensor of claim 1 including an electrical insulating coating between said temperature sensing element and said coating.

7. An intake manifold air temperature sensor, comprising a thermistor bead having a coating thereon comprising thermally conductive particles in a resin matrix.

8. The sensor of claim 7 wherein said material comprises metallic particles in said resin matrix.

9. The sensor of claim 8 wherein said metallic particles comprise aluminum particles.

10. The sensor of claim 7 wherein said material comprises non-metallic particles in said resin matrix.

11. The sensor of claim 7 including an intermediate electrical insulating coating disposed between said thermistor bead and said coating.

12. A temperature sensor, comprising a temperature sensing element having thereon an inner coating having a relatively low thermal diffusivity and an outer coating having a relatively high thermal diffusivity.

13. The sensor of claim 12 wherein said inner coating comprises a resin.

14. The sensor of claim 13 wherein said resin comprises epoxy resin.

15. The sensor of claim 12 wherein said outer coating comprises a resin matrix containing thermally conductive particles.

16. The sensor of claim 12 wherein said inner coating has a thickness of 0.01 to 0.05 mm.

17. The sensor of claim 16 wherein said outer coating has a thickness of 0.1 to 1 mm.
